(19) United States
(12) Patent Application Publication
(10) Pub. No.: US 2004/0216680 A1
(43) Pub. Date: Nov. 4, 2004

(54) Pet bed

(76) Inventor: Aaron M. Lamstein, San Rafael, CA (US)

Correspondence Address: DERGOSITS & NOAH LLP, Suite 1450, Four Embarcadero Center, San Francisco, CA, 94111, US

(21) Appl. No.: 10/801,240

(22) Filed: Mar. 15, 2004

Related U.S. Application Data
(63) Continuation-in-part of application No. 29/179,834, filed on Apr. 15, 2003.

(51) Int. Cl. A01K 29/00

(52) U.S. Cl. 119/28.5; D30/118

(57) ABSTRACT

A pet bed for use by cats, the pet bed includes a resilient and compressible fill material and an outer shell fabric defining the geometry of the pet bed as having a bottom and sides. The top is made of a plush and gas permeable fabric. A closable opening in the outer shell is provided for allowing for selective access to the interior of the outer shell fabric. A gas permeable pouch containing catnip is positioned either between the resilient, compressible fill material and the top fabric or beneath the resilient compressible fill material such that as the top fabric is depressed by the weight of a cat using the pet bed, the scent from the catnip is caused to permeate through the gas permeable pouch and gas permeable fabric.

### RELATED APLICATIONS

This application is a continuation-in-part of U.S. application Ser. No. 29/179,834, filed on Apr. 15, 2003.

### TECHNICAL FIELD

The present invention involves a pet bed and, specifically, a pet bed for use by cats. By the appropriate selection of fabrics, the pet bed can be made to be particularly attractive to cats by positioning a source of catnip strategically below the top surface of the bed promoting the scent of catnip to permeate the bed's top surface as the cat employs the bed.

### BACKGROUND OF THE INVENTION

The effect of catnip on virtually all feline species is well-known. Catnip or Nepatia cataria is a plant native to North America. The dried leaves of the catnip plant express a mint-like scent. Catnip has a hallucinogenic effect upon cats, although it is not toxic. This “catnip response” is due to the plant's active ingredient, nepetalactone.

When a cat smells catnip, it characteristically exhibits a range of behaviors somewhat dependent upon the age of a cat and whether it is capable of reproduction. Most reactions last from five to fifteen minutes and include sniffing, licking, and chewing, chin and cheek rubbing, and head-over roll and body rubbing. The feline receptor for the active ingredient, nepetalactone, is contained within the animal's vomeronasal organ located above the feline palate. The location of the vomeronasal organ may explain why cats do not react from eating gelatine capsules of catnip. Nepetalactone must be inhaled for it to reach the receptors in this organ.

Although it is commonplace to incorporate catnip in various feline toys, the use of this plant in bedding products is limited. This is perhaps explained by the desire of a cat owner to introduce a toy containing catnip to a family pet in order to observe the various sniffing, licking and rubbing reactions described previously. Such auto-induced reactions were not believed to be particularly conducive to sleeping, although, as noted below, catnip can have a beneficial effect in this regard when appropriately positioned within a suitable bedding product.

It is thus an object of the present invention to provide a pet bed specifically intended for use by one or more cats and which selectively introduces catnip to enhance the cat's sleeping experience when using such a product.

Further objects of the present invention will become more readily apparent when considering the following disclosure and appended claims.

### SUMMARY OF THE INVENTION

The present invention is directed to a pet bed for use by cats. The pet bed comprises a resilient, compressible fill material and an outer shell fabric defining the geometry of the bed as having a bottom and sides. A top fabric is provided which is both plush and gas permeable. A closeable opening in the outer shell is further provided for allowing for selective access to the interior of the outer shell fabric. A gas permeable pouch containing catnip is provided and located either between the resilient, compressible fill material and the top fabric or below the fill material such that as the top fabric is depressed by the weight of a cat using the pet bed, scent from the catnip is caused to permeate through the gas permeable pouch, fill material and gas permeable fabric.

### BRIEF DESCRIPTION OF THE FIGURES

FIG. 1 is a prospective view of the pet bed of the present invention.

FIGS. 2a through 2c are cross sectional views taken along line 2-2 of FIG. 1 showing various alternative embodiments of the present invention.

FIG. 3 is a cross sectional view of an alternative embodiment of the present invention.

### DETAILED DESCRIPTION OF THE INVENTION

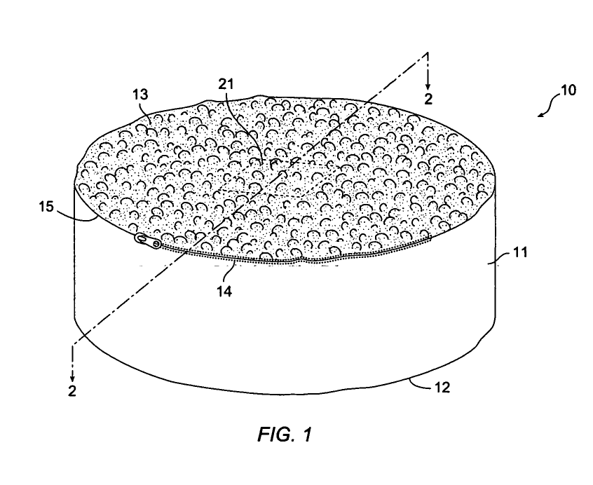

Turning to FIG. 1, pet bed 10 is shown. Although pet bed 10 can be of any generally acceptable geometric configuration such as a square, rectangle, etc. FIG. 1 shows pet bed 10 as having a substantially oval top and bottom and vertical side walls.

Pet bed 10 includes outer shell fabric 11 and 12 defining the bed's geometry. The volume of pet bed 10 is maintained by a resilient compressible fill material 16. Resilient, compressible fill material can be composed, for example, of lofty poly fiberfill such as EcoRest™ fiber available from Worldwise, Inc. of San Rafael, Calif. or poly batting commonly used in blankets and in pad filling. Top fabric 13 of pet bed 10 is comprised of a plush, high loft fabric which is gas permeable to an extent more fully described subsequently. Top fabric 13 is characterized as having a thickness and texture so as to provide a sleeping surface that a cat would find attractive both from the standpoint of comfort as well as to provide a somewhat roughened surface conducive to promote anticipated rubbing and rolling actions as the catnip creates its desired effect.

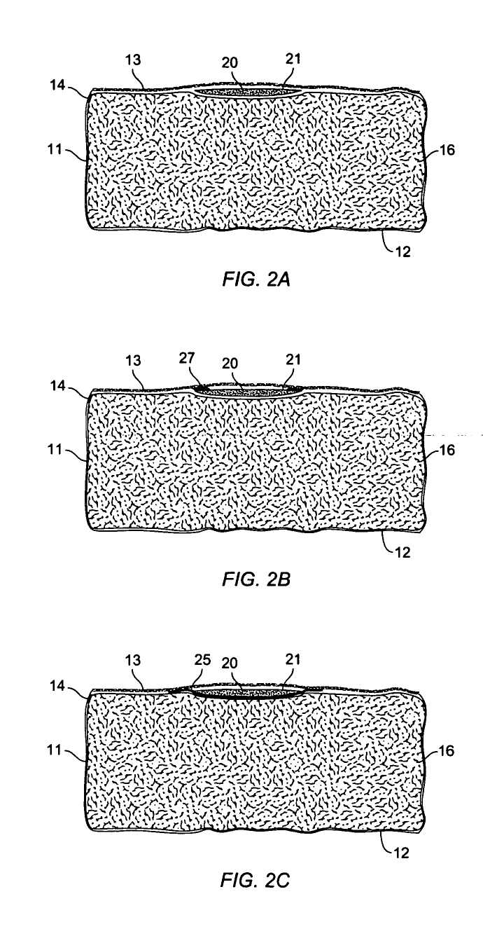

Turning to FIG. 2a, gas permeable pouch 21 is shown as containing catnip 20 and is located beneath plush, high loft fabric top surface 13 held in position by the compressible interface between resilient, compressible fill material 16 and top plush and gas permeable fabric 13. Gas permeable pouch 21 can be geometrically centered atop resilient, compressible fill material 16 shown in phantom in FIG. 1.

Gas permeable pouch 21 can be sealed as a one time use, throw away item as the effects of catnip 20 are dissipated. Alternatively, gas permeable pouch 21 can be refillable. In either case, access to the interior of pet bed 10 through any convenient closeable opening to enable a user to periodically access gas permeable pouch 21 is desirable in practicing the present invention. As shown in FIG. 1, a convenient access to the interior of pet bed 10 can be provided by zippered closure 14 configured along seam 15. Alternatively, although not shown, a hook and loop or zippered closure can be provided as well within top fabric 13.

As noted previously, gas permeable pouch 21 can be simply applied between the underside of fabric surface 13 and resilient, compressible fill material 16 and held in place by the compressible interface between these elements. Alternatively, as noted by referring to FIG. 2b, hook and loop fasteners 27 can be employed to help ensure that gas permeable pouch 21 will not be inadvertently dislodged from its preferred position proximate the geometric center of the top surface of pet bed 10 by moving or storing the pet bed or through the actions of a feline user. The same result can be achieved by providing fabric pocket 25 sized to receive gas permeable pouch 21. It is envisioned that fabric pocket 25 be sewn directly onto the interior surface of top fabric 13 employing the interior surface of top fabric 13 as one of the sidewalls of fabric pocket 21 so as not to interfere with the gas permeability of these various elements.

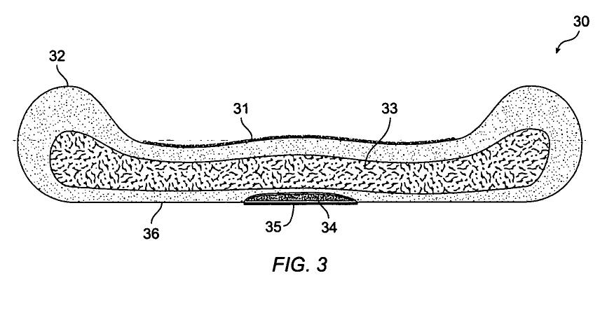

It is contemplated as a preferred embodiment that any catnip-containing pouch be positioned with respect to the top surface of the pet bed in such a fashion that as a cat positions itself upon the bed, scent from the catnip permeates its top surface thus producing the intended sensory effect. The catnip scent can be induced either by the weight of the cat compressing the catnip pouch and the cat positioning itself in the bed or by a human squeezing the pouch once positioned in the bed. In replicating the pet bed as depicted in FIG. 1, the only realistic positioning of the catnip-containing pouch is shown in FIGS. 2a-2c, that is, above the resilient compressible fill material 16 but beneath top fabric 13. However, when the resilient compressible fill material is thin enough, the catnip-containing pouch can be placed beneath the resilient compressible fill material while still producing the desired sensory effect. In this regard, reference is made to FIG. 3.

FIG. 3 depicts an alternative embodiment of the present invention whereby pet bed 30 is provided with expanded side bolsters 32 and a relatively thin pet supporting surface for supporting a cat bounded by plush and gas permeable fabric 31, identical in construction to fabric 13 as shown in FIG. 1 and bottom fabric layer 36. Between fabric 31 and 36 is placed a casing containing resilient compressible fill material 33 of the type described as compressible fill material 16 of the FIG. 1 embodiment. Because of the relatively thin dimension of resilient compressible fill material 33, pouch 34 containing catnip can be placed beneath resilient compressible fill material 33 which can be inserted within pet bed 30 through a suitable zippered or Velcro® closure 35. In fabricating this embodiment, care should be taken to limit the thickness of the fill material 33 to ensure that the catnip will be discernable at surface 31. The thickness determination is done by placing pouch 34 as shown in FIG. 3 and pressing upon the pet bed to see if odors emanating from the catnip can be perceived atop the pet bed. Alternatively, a cat can be placed upon pet bed 30 and visually observed to determine if the catnip contained within pouch 34 provides the intended behavior.

As noted previously, nepetalactone, an essential oil of catnip, evokes, through a cat's autosomal dominant gene, a range of behaviors including sniffing, licking and chewing, chin and cheek rubbing and head-over roll and body rubbing. It is a goal of the present invention to provide sufficient gas permeability both through a suitable pouch and plush and gas permeable top fabric such that as a cat jumps upon its pet bed, the weight of the cat will cause a release of the catnip smell. It is anticipated that this will induce the cat to rub, roll and subsequently settle into the bed. After the initial stimulating effect of the catnip wears off, it has been observed that cats will generally settle in for a nap. This is further induced by a relative plush top fabric which provides a synergistic effect with the catnip in promoting the anticipated chin and cheek rubbing and head-over roll and body rubbing activities.

1. A pet bed for use by cats, said pet bed comprising a resilient, compressible fill material, and an outer shell fabric defining the geometry of the pet bed as having a bottom and sides and a top, the later comprising a plush and gas permeable fabric, a closable opening in said outer shell fabric allowing for selective access to the interior of said outer shell fabric, a gas permeable pouch containing catnip located beneath said top fabric such that scent from said catnip is caused to permeate through the said gas permeable pouch and gas permeable top fabric.

2. The pet bed of claim 1 wherein said gas permeable pouch containing catnip is located between said resilient compressible fill material and said top fabric.

3. The pet bed of claim 1 wherein said gas permeable pouch containing catnip is located beneath said resilient compressible fill material.

4. The pet bed of claim 1, wherein said gas permeable pouch is characterized as having a closable opening so that catnip can be periodically refillably introduced to said pouch.

5. The pet bed of claim 1, wherein said gas permeable pouch is selectively attachable to an interior surface of said top fabric.

6. The pet bed of claim 3, wherein said gas permeable pouch is selectively attachable to an interior surface of said top fabric by hook-and-loop fasteners.

7. The pet bed of claim 3, wherein said gas permeable pouch is selectively attachable to an interior surface of said top fabric by providing said interior surface with a fabric pocket sized to receive said pouch.

8. The pet bed of claim 1 wherein as said top fabric is depressed by the weight of the cat using said pet bed, scent from said catnip is caused to permeate through said gas permeable pouch and gas permeable top surface.

9. The pet bed of claim 1 wherein as said gas permeable pouch is squeezed, scent from said catnip is caused to permeate through said gas permeable pouch and gas permeable top surface.
